(19) United States
(12) Patent Application Publication
(10) Pub. No.: US 2006/0162787 A1
(43) Pub. Date: Jul. 27, 2006

(54) Control valve for high pressure fluid

(76) Inventor: Hsin-Cheng Yeh, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/039,893

(22) Filed: Jan. 24, 2005

(51) Int. Cl. F15B 13/044

(52) U.S. Cl. 137/596.17

(57) ABSTRACT

A control valve for high pressure fluid includes a valve seat, a valve, a trigger, a washer and an elastic element. The valve seat comprises a chamber, an input channel, an output channel and a pressure release channel. All of the channels are interconnected to the chamber, respectively. The valve, the washer and the elastic element are located within the chamber. The elastic element is constantly urging the valve towards the trigger and against the washer to block the input channel from interconnecting with the output channel, while the output channel and the pressure release channel are interconnected with each other. When the trigger pushes the valve away from the washer, it blocks the pressure release channel and interconnects the input channel and the output channel.

### BACKGROUND OF THE INVENTION

1. Field of the Invention

This invention relates to a control valve for high pressure fluid, and more particularly to a spherical valve incorporated with a washer to seal high pressure fluid channels.

2. Description of the Prior Art

High pressure fluid control valves are mostly used for paintball guns to control air input, pneumatic power tools, high pressure water guns and medical equipments. They usually use high pressure fluid tanks as power sources. However, the high pressure fluid requires a higher pressure, and the tank has to be in a sealed position in order to maintain a high efficiency. Therefore, the valve has to be in a sealed position as well. However, when the operation is in a halt or temporary stop, the high pressure fluid is still remained in the equipment, which is highly explosive. Therefore, the pressure must be released from the equipment for safe reason.

A conventional control valve uses a stud valve with O-shaped rings to slide in a chamber of a valve seat to block or connect an input channel, an output channel and a pressure release channel. The O-shaped rings are engaged with the inner wall of the chamber. The valve is slidable in the chamber to block the channels.

However, the O-shaped rings have a lot of friction in moving. Thus it requires more energy to move the O-shaped rings. Further, when moving the O-shaped rings, due to its elastic character, part of the rings will be squeezed into the channels. Thus when pulling the O-shaped rings away from the channels, part of the rings may be cut and shorten the lifespan.

### SUMMARY OF THE INVENTION

It is the primary objective of the present invention to provide a control valve for high pressure fluid, which is easy to operate and is harmless to products.

It is another objective of the present invention to provide a control valve for high pressure fluid, which is safe in operation.

It is a further objective of the present invention to provide a control valve for high pressure fluid, which has a longer lifespan.

### BRIEF DESCRIPTION OF THE DRAWINGS

FIG. 1 is a cross-sectional view of the present invention;

FIG. 2 is a cross-sectional view of the present invention in an operation status;

FIG. 3 is a side view depicting the present invention installed in a paintball gun, partially sectioned, and

FIG. 4 is a view similar to FIG. 3 in an operation status.

### DETAILED DESCRIPTION OF THE PREFERRED EMBODIMENT

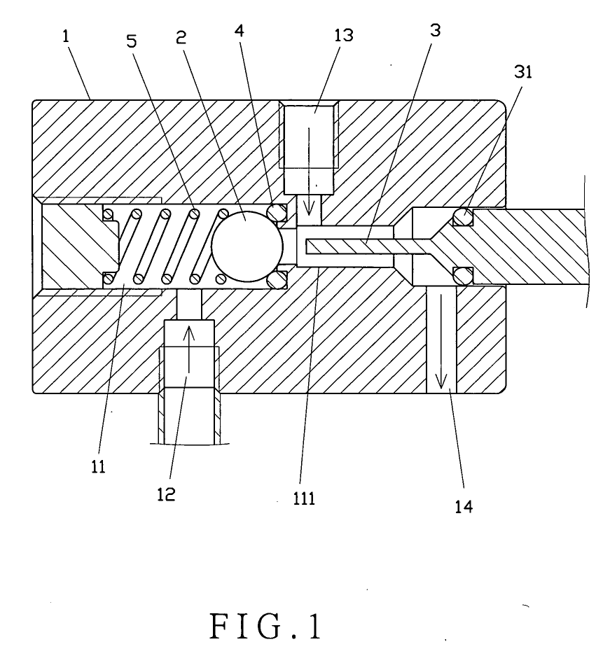

As shown in FIG. 1, a control valve of the present invention comprises a valve seat 1, a valve 2, a trigger 3, a washer 4, and an elastic element 5.

The valve seat 1 comprises a chamber 11, an input channel 12, an output channel 13 and a pressure release channel 14. The input channel 12, the output channel 13 and the pressure release channel 14 are interconnected with the chamber 11, respectively. One side wall of the chamber 11 is formed with a neck 111. The output channel 13 is located at the neck 111 and interconnected with the chamber 11, while the input channel 12 and the pressure release channel 14 are located at respective sides of the neck 111 and interconnected with the chamber 11. The elastic element 5, the valve 2 and the washer 4 are located within the chamber 11. The washer 4 engages with one side of the neck 111. The valve 2 is a spherical shape. The valve 2 is urged by the elastic element 5 towards the washer 4 constantly.

The trigger 3 is inserted into the chamber 11 from the end opposing the valve 2 with one end engaging with the valve 2 through the washer 4. The trigger 3 is provided with another washer 31 at the other end. When the valve 2 is urged by the elastic element 5, the trigger 3 is pushed backward. Thus the valve 2 blocks the input channel 12 from interconnecting with the output channel 13.

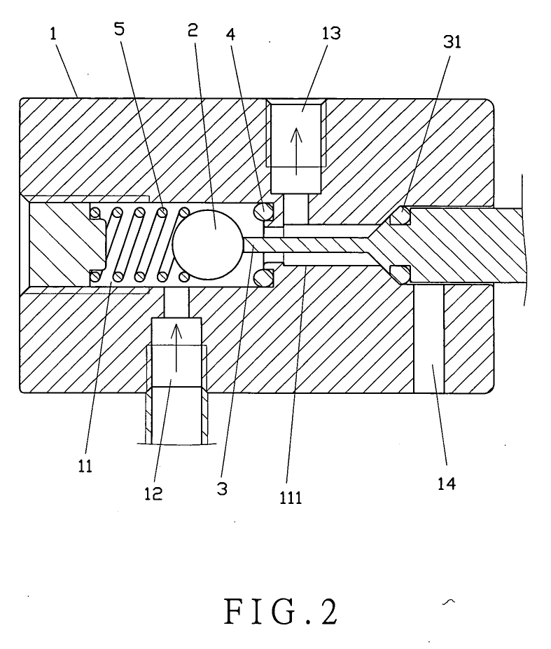

When a pushing force is applied to the trigger 3, the valve 2 will be pushed to press the elastic element 5, which allows the input channel 12 to interconnect with the output channel 13, while the pressure release channel 14 is blocked by the trigger 3 from interconnecting with the output channel 13, as shown in FIG. 2.

When the control valve is in an idle status, which means no high pressure fluid is inputted into the chamber 11 and the residue high pressure fluid is ready to drain out the chamber 11, as shown in FIG. 1. When the pushing force of the trigger 3 is released, the elastic element 5 urges the valve 2 backward to engage with the washer 4, so as to block the input channel 12 from interconnecting with the output channel 13. The output channel 13 in turn is interconnected with the pressure release channel 14. Thus the remaining fluid in the output channel 13 will be drained from the pressure release channel 14.

Due to the principle of fluid input and output control system on paintball guns, pneumatic equipments, and many other equipments are identical, this application will only describe a paintball gun, which should not be deemed as the sole purpose of this invention.

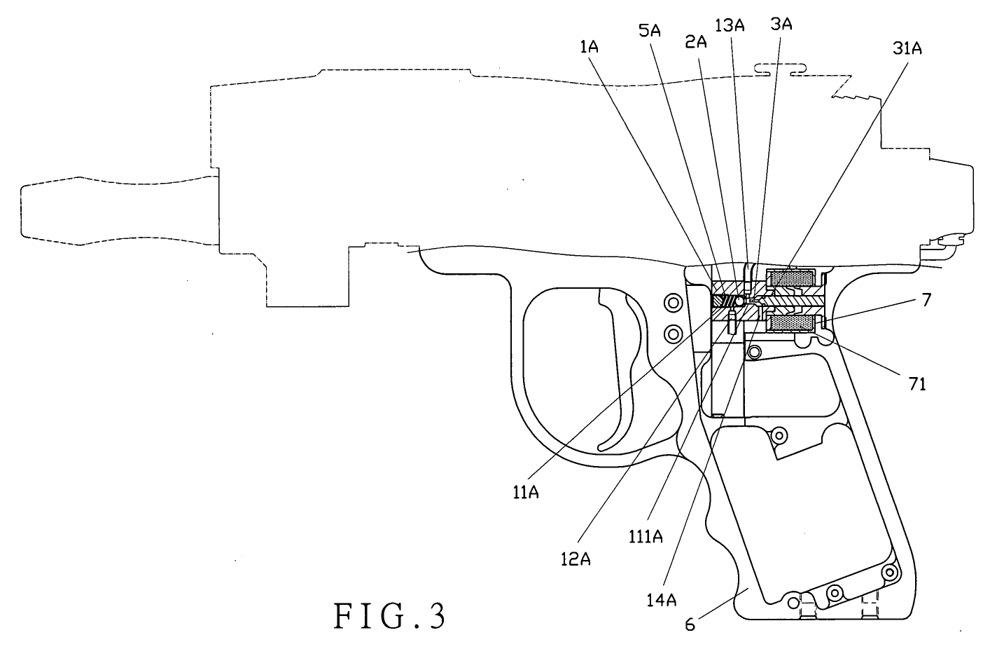

A paintball gun 6, as shown in FIG. 3, comprises an electromagnetic valve 7 incorporated with the present invention, which comprises an electro magnet 71, a valve seat 1A, a valve 2A, a trigger 3A, a washer 4A, and an elastic element 5A.

The valve seat 1A comprises a chamber 11A, an input channel 12A, an output channel 13A, and a pressure release channel 14A. The input channel 12A, the output channels 13A and the pressure release channel 14A are interconnected with the chamber 11A, respectively. The chamber 11A comprises a neck 111A with the output channel 13A formed thereat, while the input channel 12A and the pressure release channel 14A are formed at respective sides of the neck 111A to interconnect with the chamber 11A. The washer 4A engages with one side of the neck 111A. The elastic element SA, the valve 2A and the washer 4A are located in the chamber 11A. The valve 2A is urged by the elastic element 5A against the washer 4A, which blocks the input channel 12A from interconnecting with the output channel 13A. The trigger 3A inserted into the chamber 11A is provided with another washer 31A at the other end. This trigger 3A is linked with the electro magnet 71.

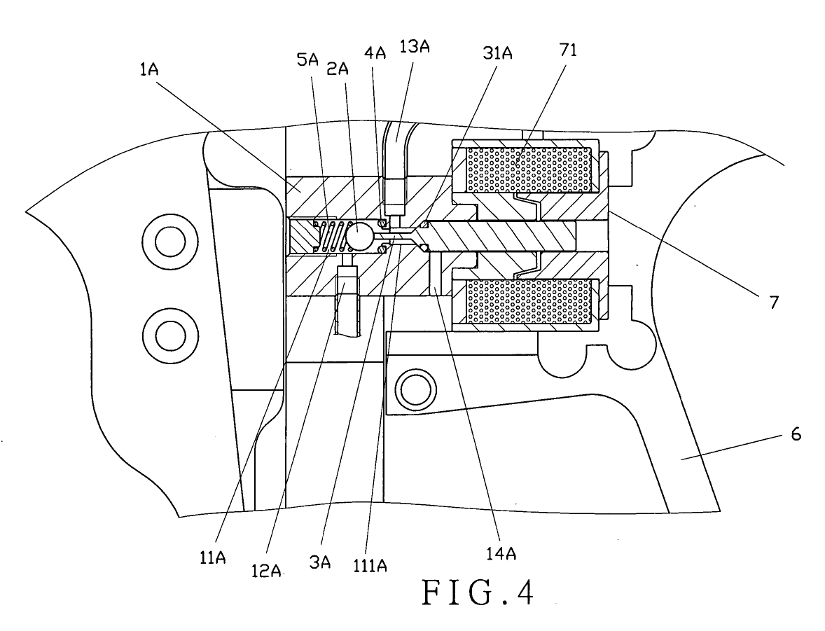

To operate the present invention, as shown in FIG. 4, the electro magnet 71 links the trigger 3A to push the valve 2A and the elastic element 5A, which interconnects the input channel 12A and the output channel 13A, but blocks the pressure release channel 14A, to form a channel for high pressure fluid to flow smoothly.

When the control valve is in an idle status, the residue high pressure fluid in the chamber 11A and the output channel 13A is to be drained out to prevent an accident happened, as shown in FIG. 3. The electro magnet 71 is activated to link the trigger 3A to retreat, while the elastic element 5A urges the valve 2A towards the washer 4A to block the input channel 12A from interconnecting with the output channel 13A. The output channel 13A in turn is interconnected with the pressure release channel 14A, thus the residue high pressure fluid is drained out from the pressure release channel 14A.

What is claimed is:

1. A control valve for high pressure fluid comprising a valve seat, a valve, a trigger, a washer and an elastic element, said valve seat comprising a chamber, an input channel, an output channel and a pressure release channel, all of said channels being interconnected with said chamber, respectively, said elastic element, said valve and said washer being located within said chamber, said elastic element urging said valve towards said washer to block said input channel from interconnecting with said output channel, said trigger being inserted into said chamber and engaging with said valve, when a pushing force is applied to said trigger, said valve and said elastic element being pushed forward, said input channel and said output channel being interconnected and high pressure fluid being able to flow through said chamber; when said pushing force is disappeared, said elastic element urging said valve toward said washer, said output channel being interconnected with said pressure release channel for residue high pressure fluid to be drained out from said pressure release channel.

2. The control valve for high pressure fluid, as recited in claim 1, wherein said valve is a spherical shape.

3. The control valve for high pressure fluid, as recited in claim 1, wherein said chamber comprises a neck with said output channel located thereat, said input channel and said pressure release channel being located at respective sides of said neck to interconnect with said chamber, said washer engaging with one end of said neck.

4. The control valve for high pressure fluid, as recited in claim 1, wherein said trigger is provided with another washer to block said output channel. from interconnecting with said pressure release channel.

5. The control valve for high pressure fluid, as recited in claim 1, wherein said trigger is activated by an electro magnet.

6. The control valve for high pressure fluid, as recited in claim 1, further comprising an electro magnet which activates said trigger to extend into said chamber.
